(19) United States
(12) Patent Application Publication
(10) Pub. No.: US 2026/0351845 A1
(43) Pub. Date: Nov. 5, 2026

(54) STABLE UWB AND BLE ANTENNA COMBINATION FOR MODULES

(71) Applicant: Qorvo US, Inc., Greensboro, NC (US)

(72) Inventor: Jan-Willem Zweers, Nieuwleusen (NL)

(21) Appl. No.: 19/545,488

(22) Filed: Feb. 20, 2026

Related U.S. Application Data
(60) Provisional application No. 63/859,242, filed on Aug. 7, 2025.
(60) Provisional application No. 63/798,825, filed on May 2, 2025.

(51) Int. Cl. H01Q 1/52; H01Q 5/25; H01Q 21/28

(52) U.S. Cl. CPC H01Q 1/52; H01Q 5/25; H01Q 21/28

(57) ABSTRACT

Embodiments of a radio frequency (RF) device and methods of manufacturing the same are disclosed. The RF device includes a module substrate and a module conductive plane integrated with the module substrate. The module conductive plane defines a side edge, the side edge defining a first end and a second end oppositely disposed from the first end. The module conductive plane defines a first edge-enabled void isolator (EEVI), a second EEVI, and an edge-enabled void antenna (EEVA) that each extends into the module conductive plane along the side edge of the module conductive plane. The first EEVI is positioned at the first end of the side edge, and the second EEVI is positioned at the second end of the side edge. The EEVA is positioned between the first EEVI and the second EEVI along the side edge, where the first and second EEVI isolate the RF device.

### RELATED APPLICATIONS

This application claims the benefit of provisional patent application serial number 63/859,242, filed Aug. 7, 2025, and claims the benefit of provisional patent application serial number 63/798,825, filed May 2, 2025, the disclosures of which are hereby incorporated herein by reference in their entireties.

### FIELD OF THE DISCLOSURE

This disclosure relates generally to radio frequency antenna devices.

### BACKGROUND

To simplify the integration of complex radio systems such as ultra wideband (UWB) and Bluetooth® Low Energy (BLE) into a sub-product, manufacturers can utilize a radio frequency (RF) radio module. This module contains all the intricate RF circuits and layout solutions, allowing customers to implement advanced wireless. When these radio modules also include the necessary antennas, the integration process becomes even more convenient for product developers.

However, incorporating antennas into a compact radio module presents several challenges. Smaller radio modules are more versatile and can fit into a wider range of sub-products, but they require smaller antennas, which are often limited in performance due to the effect of the geometry of the products in which they are used. For example, small antennas tend to have narrow bandwidths and are more susceptible to detuning due to the external geometry of the conductive features in the overall system. More specifically, when a radio module with integrated antennas is mounted on the main printed circuit board, which includes a ground-plane, the proximity and geometry of the ground-plane can significantly affect antenna performance. Because the antennas are small, any negative impact from the ground-plane can have a substantial effect on their efficiency and overall functionality.

### SUMMARY

Embodiment 1. A radio frequency (RF) device, includes: a module substrate; a module conductive plane integrated with the module substrate, wherein: the module conductive plane defines a side edge; the side edge defining a first end and a second end oppositely disposed from the first end; the module conductive plane defining a first edge-enabled void isolator (EEVI), a second EEVI, and an edge-enabled void antenna (EEVA) that each extends into the module conductive plane along the side edge of the module conductive plane; the first EEVI being positioned at the first end of the side edge; the second EEVI being positioned at the second end of the side edge; and the EEVA being positioned between the first EEVI and the second EEVI along the side edge.

Embodiment 2. The RF device of embodiment 1, further includes: a main substrate; a main conductive plane integrated with the main substrate, wherein the main conductive plane is connected to the module conductive plane.

Embodiment 3. The RF device of embodiment 2, wherein: the side edge is a first side edge; the module conductive plane defines a second side edge and a third side edge; the second side edge extends from the first end of the first side edge; the third side edge extends from the second end of the first side edge; the first EEVI is positioned at the second side edge; and the second EEVI is positioned at the third side edge.

Embodiment 4. The RF device of embodiment 3, further includes: first side solder pads along the second side edge, the first side solder pads connecting the first EEVI to the main conductive ground plane; second side solder pads along the third side edge, the second side solder pads connecting the second EEVI to the main conductive ground plane.

Embodiment 5. The RF device of embodiment 2, wherein: the main substrate and the main conductive plane define a printed circuit board (PCB) side edge; the side edge of the module conductive plane is retracted with respect to the PCB side edge.

Embodiment 6. The RF device of embodiment 2, wherein the module substrate is mounted on the main substrate.

Embodiment 7. The RF device of embodiment 1, wherein the EEVA is a first EEVA and wherein: the module conductive plane defines a second EEVA and a third EEVI that each extends into the module conductive plane along the side edge of the module conductive plane; the second EEVA and the third EEVI being positioned between the first EEVI and the second EEVI along the side edge; and the third EEVI being positioned between the first EEVA and the second EEVA along the side edge.

Embodiment 8. The RF device of embodiment 7, wherein the first EEVA is a Bluetooth® Low Energy (BLE) antenna and the second EEVA is an ultra wideband (UWB) antenna.

Embodiment 9. The RF device of embodiment 1, wherein the conductive plane defines one or more passive matching elements that are formed in a void of the EEVA, the passive matching elements being configured to provide matching for the EEVA.

Embodiment 10. The RF device of embodiment 1, further includes a mounting area for mounting at least one electronic component, the first EEVI, the second EEVI, and the EEVA being outside of the mounting area.

Embodiment 11. A method of manufacturing a radio frequency (RF) device, includes: forming a module substrate; integrating a module conductive plane with the module substrate, wherein the module conductive plane defines a side edge, the side edge defining a first end and a second end oppositely disposed from the first end; forming a first edge enabled void isolator (EEVI), a second EEVI, and an edge enabled void antenna (EEVA) that each extends into the module conductive plane along the side edge of the module conductive plane, wherein the first EEVI is positioned at the first end of the side edge, the second EEVI is positioned at the second end of the side edge, and the EEVA is positioned between the first EEVI and the second EEVI along the side edge

Embodiment 12. The method further includes: forming a main substrate; integrating a main conductive plane with the main substrate; connecting the main conductive plane to the module conductive plane.

Embodiment 13. A user element that includes a radio frequency (RF) device, the RF device includes: a module substrate; a module conductive plane integrated with the module substrate, wherein: the module conductive plane defines a side edge; the side edge defining a first end and a second end oppositely disposed from the first end; the module conductive plane defining a first edge-enabled void isolator (EEVI), a second EEVI, and an edge-enabled void antenna (EEVA) that each extends into the module conductive plane along the side edge of the module conductive plane; the first EEVI being positioned at the first end of the side edge; the second EEVI being positioned at the second end of the side edge; and the EEVA being positioned between the first EEVI and the second EEVI along the side edge.

Embodiment 14. The user element of embodiment 13, wherein the RF device further includes: a main substrate; a main conductive plane integrated with the main substrate, wherein the main conductive plane is connected to the module conductive plane.

Embodiment 15. The RF device of embodiment 14, wherein: the side edge is a first side edge; the module conductive plane defines a second side edge and a third side edge; the second side edge extends from the first end of the first side edge; the third side edge extends from the second end of the first side edge; the first EEVI is positioned at the second side edge; and the second EEVI is positioned at the third side edge.

Embodiment 16. The RF device of embodiment 15, further includes: first side solder pads along the second side edge, the first side solder pads connecting the first EEVI to the main conductive ground plane; second side solder pads along the third side edge, the second side solder pads connecting the second EEVI to the main conductive ground plane.

Embodiment 17. The RF device of embodiment 14, wherein: the main substrate and the main conductive plane define a printed circuit board (PCB) side edge; and the side edge of the module conductive plane is retracted with respect to the PCB side edge.

Embodiment 18. The RF device of embodiment 14, wherein the module substrate is mounted on the main substrate.

Embodiment 19. The RF device of embodiment 13, wherein the EEVA is a first EEVA and wherein: the module conductive plane defines a second EEVA and a third EEVI that each extends into the module conductive plane along the side edge of the module conductive plane; the second EEVA and the third EEVI being positioned between the first EEVI and the second EEVI along the side edge; and the third EEVI being positioned between the first EEVA and the second EEVA along the side edge.

Embodiment 20. The RF device of embodiment 19, wherein the first EEVA is a Bluetooth® Low Energy (BLE) antenna and the second EEVA is an ultra wideband (UWB) antenna.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is an embodiment of a radio frequency (RF) device, in accordance with some embodiments.

FIG. 2 is an RF device that includes the RF device described above with respect to FIG. 1, in accordance with some embodiments.

FIG. 3 is a top view of a module printed circuit board shown in FIG. 1, in accordance with some embodiments.

FIG. 4 is a mountable RF antenna module, in accordance with some embodiments.

FIG. 5 is a graph that illustrates the antenna efficiency of an edge-enabled void antenna (EEVA) capable of being used for ultra wideband (UWB) that is shown in FIG. 1, FIG. 2, and FIG. 3 versus frequency, in accordance with some embodiments.

FIG. 6 is a graph that illustrates an S22 parameter in decibels of the EEVA capable of being used for UWB that is shown in FIG. 1, FIG. 2, and FIG. 3 versus frequency, in accordance with some embodiments.

FIG. 7 is a Smith chart that illustrates the antenna impedance as the S22 parameter of the EEVA capable of being used for UWB that is shown in FIG. 1, FIG. 2, and FIG. 3 throughout a frequency sweep, in accordance with some embodiments.

FIG. 8 is a graph that illustrates radiated power from the EEVA capable of being used for UWB that is in decibels shown in FIG. 1, FIG. 2, and FIG. 3 versus frequency, in accordance with some embodiments.

FIG. 9 is a flowchart 900 that illustrates a method of manufacturing an RF device, in accordance with some embodiments.

FIG. 10 is a user element, in accordance with some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that comcomthese concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

This disclosure describes embodiments of radio frequency (RF) devices that include edge-enabled void constructions (EEVCs) formed along a side edge of a module conductive plane of a printed circuit board. These EEVCs include both edge-enabled void antennas (EEVAs), which serve as integrated antenna elements (such as Bluetooth® Low Energy and ultra wideband antennas), and edge-enabled void isolators (EEVIs), which are strategically placed to minimize electromagnetic coupling and interference with the EEVAs. In some embodiments, the RF device also features side solder pads along its edges, which are designed to electrically and mechanically connect the module’s conductive plane to that of a main printed circuit board, while maintaining high-frequency signal integrity.

A key aspect of the design is the placement of two EEVIs—one at each end of the side edge with the EEVC of the module conductive plane. These EEVIs at each end of the side edge act as the initial conductive plane disruptions for currents traveling along the side edge and may be seen by the EEVAs (antennas) as series inductors. Their EEVIs at the ends of the side edge provide isolation for the EEVAs, ensuring that when the RF module is mounted to a main printed circuit board, the edge currents and antenna performance are less affected by the shape, size, or layout of the main printed circuit board. This isolation allows the RF module to be used as a drop-in solution on any main printed circuit board without requiring special consideration of external connected components or placement tolerances, thereby preserving antenna impedance and overall RF performance regardless of the main board’s geometric characteristics. A module can include one or more EEVAs and one or more EEVIs. In one likely embodiment, the module includes one or more EEVAs and one but most probably at least two EEVIs. In some embodiments, an EEVA can be another type of antenna (e.g., a FEEST antenna).

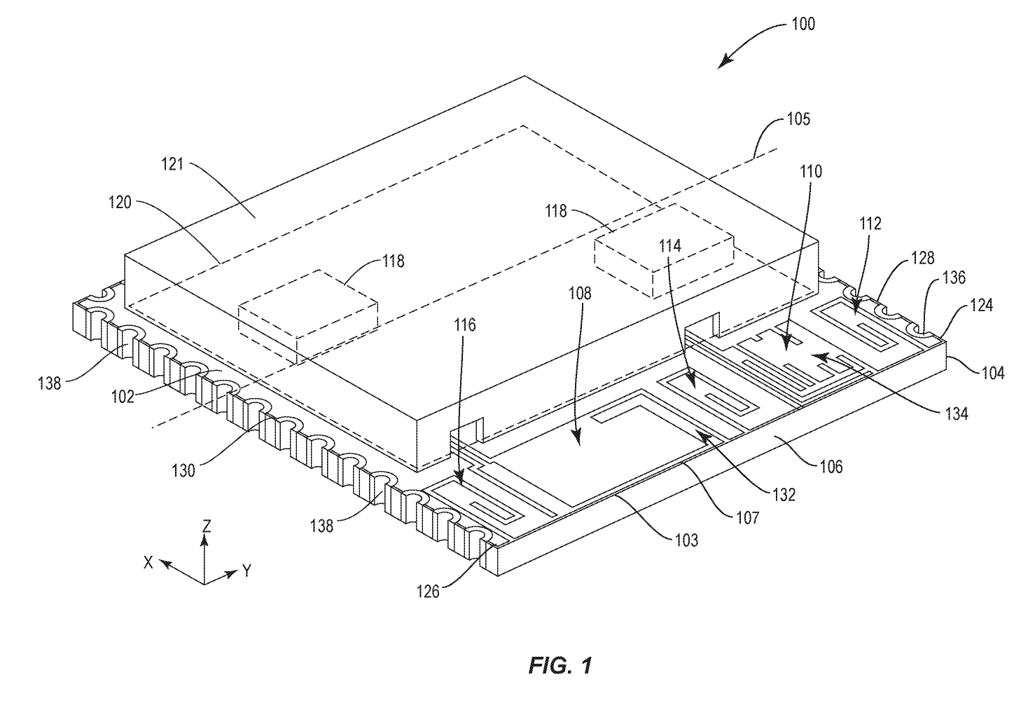

FIG. 1 is an embodiment of a radio frequency (RF) device 100, in accordance with some embodiments.

The RF device 100 is an RF module that includes EEVCs along a geometric perimeter of a module conductive plane 102. The module conductive plane 102 is formed as part of a printed circuit board 104. More specifically, the printed circuit board 104 includes a module substrate 106 and the module conductive plane 102, wherein the module conductive plane 102 is integrated with the module substrate 106. The printed circuit board 104 includes the module substrate 106, wherein the module substrate 106 forms the body of the printed circuit board 104. In some embodiments, the module substrate 106 is formed from an epoxy laminate sheet, glass, fiberglass, Teflon, metal, and any other acceptable material used to provide surface mount technology. In some embodiments, a conductive structure is formed within the module substrate 106 in order to form connections between electronic components (see electronic components 118) mounted on the printed circuit board 104. In some embodiments, the module conductive plane 102 is a ground plane that is configured to be referenced as a ground voltage.

In FIG. 1, the module conductive plane 102 is formed on a top surface 103 of the module substrate 106 of the printed circuit board 104. In other embodiments, the module conductive plane 102 may be formed on a bottom surface of the module substrate 106. In still other embodiments, the module conductive plane 102 is formed as a conductive layer within the module substrate 106. The module conductive plane 102 may be a ground plate in some embodiments.

In some embodiments, the module conductive plane 102 is a ground plate used to provide a ground voltage for some or all of the electronic components mounted on the printed circuit board 104. Various EEVC apparatuses are formed within the module conductive plane 102 and extend toward a center line 105 of from a side edge 107 of the module conductive plane 102 (and of the printed circuit board 104).

The EEVCs formed by the module conductive plane 102 include edge-enabled void antennas (EEVAs) 108, 110 and edge-enabled void isolators (EEVIs) 112, 114, 116 (referred to collectively as EEVCs 108, 110, 112, 114, 116). Each of the EEVCs 108, 110, 112, 114, 116 defines an EEVC void that extends into the module conductive plane 102, wherein the EEVC void of each of the EEVCs 108, 110, 112, 114, 116 defines an EEVC perimeter that extends into the module conductive plane 102.

The printed circuit board 104 is utilized to mount and distribute signals between various electronic components 118 mounted on a mounting area 120. Examples of electronic components 118 that may be mounted on the printed circuit board 104 include microprocessors, transceiver circuitry, digital processing circuitry, analog circuitry, front-end circuitry, digital signal processors, filters, amplifiers, power regulation circuitry, and/or the like. These electronic components 118 are provided as integrated circuits formed on semiconductors packed in electronic circuit packages, in accordance with some embodiments. As shown, the electronic components 118 are covered by an overmold 121. In some embodiments, the overmold 121 may have an electromagnetic shield. The overmold 121 is typically formed from materials such as thermoplastic elastomers (TPE), silicone, or other engineered polymers. These materials are selected for their flexibility, durability, electrical insulation, and resistance to harsh environmental factors such as moisture, dust, and temperature extremes. To meet Federal Communication Commission (FCC) requirements for RF emissions, the overmold is integrated with an electromagnetic shield. This shield is usually realized by applying a conductive layer—such as metallized coatings, conductive inks, or nano-enhanced polymers containing materials such as carbon nanotubes or graphene—over or within the overmold 121. In still other embodiments, the overmold 121 is replaced with an electromagnetic shield so that no overmold 121 is provided. Thus, the overmold 121 in FIG. 1 would be replaced with an electromagnetic shield. In some embodiments, the electromagnetic shield is formed from a conductive material, such as a metal and forms a radio frequency (RF) shield.

In this embodiment, both the center line 105 and the side edge 107 are parallel to one another and to a Y-axis. The side edge 107 defines a first end 124 and a second end 126. The Y-axis defines a first horizontal dimension of the printed circuit board 104. A second horizontal dimension of the printed circuit board 104 is defined by an X-axis, which is orthogonal to the Y-axis. Side edge 128 of the module conductive plane 102 (and of the printed circuit board 104) extends from the first end 124 of the side edge 107. In this embodiment, the side edge 128 is parallel with the X-axis and is thus orthogonal to the side edge 107. Side edge 130 of the module conductive plane 102 (and of the printed circuit board 104) extends from the second end 126 of the side edge 107. In this embodiment, the side edge 130 is parallel with the X-axis and is thus orthogonal to the side edge 107. Furthermore, in this embodiment, the side edge 130 is opposite (i.e., on an opposite side) of the side edge 128.

The EEVCs 108, 110, 112, 114, 116 are formed by a void using the module conductive plane 102. The void has a defined geometric shape (e.g., polygonal-shaped, elliptical-shaped, meandering path, and isolated island) and a defined thickness (e.g., 33 micrometers or less). In some embodiments, the EEVC voids of the EEVCs 108, 110, 112, 114, 116 are filled with the module substrate 106, while in other embodiments, the EEVC voids are empty. The remaining material of the module conductive plane 102 around the perimeter of the voids of the EEVCs 108, 110, 112, 114, 116 provide the conductive material of the EEVCs 108, 110, 112, 114, 116. Each of the EEVCs 108, 110, 112, 114, 116 extends into the module conductive plane 102 toward the center line 105 from the side edge 107. Due to the skin effect of the module conductive plane 102, current flows through a geometric perimeter of the module conductive plane 102 with the EEVC void. The module conductive plane 102 has a geometric perimeter 132. Hereinafter, the geometric perimeter 132 refers to the continuous line forming a boundary of the module conductive plane 102. For example, the geometric perimeter 132 can refer to the four edges of a rectangular-shaped conductive plane or the circle defining the circumference of a circular-shaped conductive plane.

According to an embodiment of the present disclosure, the EEVCs 108, 110, 112, 114, 116 are formed in the module conductive plane 102 by creating the EEVC voids in the module conductive plane 102 or on a conductive plane inserted in the module conductive plane 102. The EEVC voids extend from the geometric perimeter toward the center line 105 of the module conductive plane 102. The EEVC voids can be in any geometric shape. In FIG. 1, the EEVC void of the EEVA 108 forms the EEVA 108 as a portion of a rectangle. Similarly, the EEVC void of the EEVA 110 also forms the EEVA 110 as a portion of a rectangle. The EEVC void of each of the EEVIs 112, 114, 116 form a meandering path so that the EEVIs 112, 114, 116 form curls.

With respect to the EEVAs 108, 110, the EEVAs 108, 110 are connected to an RF port, as explained in further detail below. The RF port is configured to receive an outgoing RF signal. The outgoing RF signal corresponds to a defined bandwidth of wavelength that is proportionally related to velocity and inversely related to frequency of the outgoing RF signal. With respect to the EEVIs 112, 114, 116, the EEVIs 112, 114, 116 are not connected to an RF port.

The EEVI 112 is positioned at the first end 124 of the side edge 107 and the EEVI 116 is positioned at the second end 126 of the side edge 107. The EEVA 110, the EEVI 114, and the EEVA 108 are each positioned between the EEVI 112 and the EEVI 116 along the side edge 107. By being at the first end 124 and second end 126 of the side edge 107, the EEVIs 112, 116 provide isolation for the EEVAs 108, 110 so that the RF device 100 can be used as a module. The EEVIs 112, 116 are the initial conductive plane disruptions through which currents along the side edge 107 pass and which do not pass through the EEVAs 108, 110. The EEVAs 108, 110 see these EEVIs 112, 116 as series inductors. For this reason, the edge currents will be less impactful to other conductive plane disruptions when the RF device 100 is mounted to another printed circuit board. Again, the EEVIs 112, 116 thus provide the isolation needed so that the RF device 100 can be utilized without special consideration of the impact of external connected components. The shape of a printed circuit board to which the RF device 100 is mounted is unknown and the module conductive plane 102 may decrease the antenna impedance. The EEVIs 112, 116 also make sure the impact of module placement tolerances is less visible in performance and thus allow the antenna to be designed to mount the RF device on any main printed circuit board without taking into account the shape of the main printed circuit board.

In this embodiment, the EEVA 108 is a Bluetooth® Low Energy (BLE) antenna while the EEVA 110 is an ultra wideband (UWB) antenna. The EEVA 110 is positioned between the EEVI 112 and the EEVI 114 along the side edge 107. The EEVI 114 is positioned between the EEVA 110 and the EEVA 108 along the side edge 107. The EEVI 114 provides isolation between the EEVA 110 and the EEVA 108 along the side edge 107. The EEVA 108 is positioned between the EEVI 114 and the EEVI 116 along the side edge 107.

The module conductive plane 102 is formed so that one or more passive matching elements 134 are formed in the EEVC void of the EEVA 110. The passive matching elements 134 are configured to provide matching for the EEVA 110. The passive matching elements 134 make the EEVA 110 (which is a UWB antenna in FIG. 1) more broadband. The EEVA 110 is isolated by the EEVIs 112, 114, which have curl structures so that the EEVA 108 (and any other EEVA that may be formed on the module conductive plane 102) does not have significant electromagnetically coupling. In some embodiments, without the passive matching elements 134, the EEVA 110 can only cover frequency bands associated with channel 9 (CH9) or above. In some embodiments, the EEVA 110 is about 1/12th of a Lambda long at 6.25GHz.

In FIG. 1, the printed circuit board 104 includes side solder pads 136 (not all labeled for the sake of clarity) along the side edge 128. Additionally, the printed circuit board 104 includes side solder pads 138 (not all labeled for the sake of clarity) along the side edge 130. The side solder pads 136, 138 may be used to connect the module conductive plane 102 to the conductive plane (not shown in FIG. 1) of a main printed circuit board (not shown in FIG. 1) and to help mount the RF device 100 to the main printed circuit board. Side solder pads 136, 138 are patterned along the side edges 128, 130 where indentations are created along the side edges 128, 130 and filled with a conductive material (e.g., a metal such as copper, gold, and/or nickel). The size and dimensions of the side solder pads 136, 138 are often minimized to reduce parasitic capacitance and maintain signal integrity at high frequencies. In some embodiments, side solder pads 136, 138 are connected to the main printed circuit board using wires or flat conductors soldered directly onto the side solder pads 136, 138 and the appropriate structures of the main printed circuit board. This creates both an electrical connections and supporting mounting attachment between the printed circuit board 104 and the main printed circuit board. However, any appropriate connection mechanism may be used to connect the side solder pads 136, 138 to the main printed circuit board.

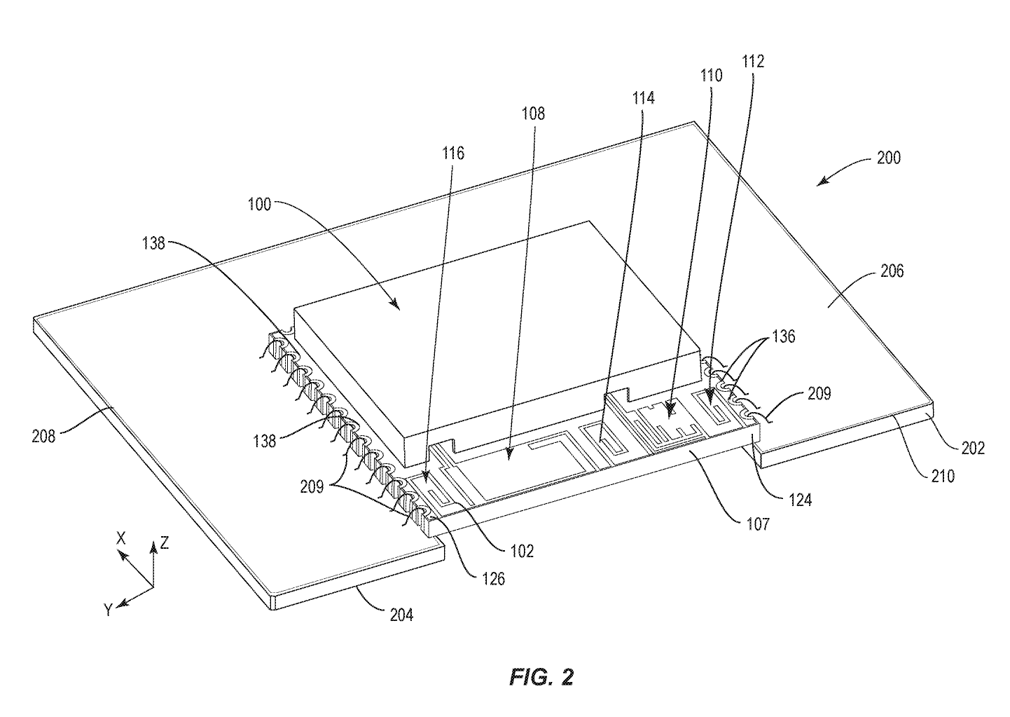

FIG. 2 is an RF device 200 that includes the RF device 100 described above with respect to FIG. 1.

The RF device 200 includes the RF device 100 mounted to a main printed circuit board 202. The main printed circuit board 202 includes a main substrate 204 and a main conductive plane 206, wherein the main conductive plane 206 is integrated with the main substrate 204. The main substrate 204 forms the body of the main printed circuit board 202. In some embodiments, the main substrate 204 is formed from an epoxy laminate sheet, glass, fiberglass, Teflon, metal, and any other acceptable material used to provide surface mount technology. In some embodiments, a conductive structure is formed within the main substrate 204 in order to form connections between electronic components (see electronic components 118) mounted on the main printed circuit board 202. In some embodiments, no electronic components are mounted directly on the main printed circuit board 202. In some embodiments, the main conductive plane 206 is a ground plane that is configured to be referenced as a ground voltage.

In FIG. 2, the main conductive plane 206 is formed on a top surface 208 of the module substrate 106 of the printed circuit board 104. In other embodiments, the main conductive plane 206 may be formed on a bottom surface of the main substrate 204. In still other embodiments, the main conductive plane 206 is formed as a conductive layer within the main substrate 204. The main conductive plane 206 may be a ground plate in some embodiments.

In FIG. 2, the side solder pads 136, 138 extend to and cover a portion of the main conductive plane 206 of the main printed circuit board 202. In this embodiment, wires 209 (not all labelled for the sake of clarity) connect the side solder pads 136, 138 to the main conductive plane 206. The side solder pads 136, 138 are connected to the module conductive plane 102 and thereby connect the module conductive plane 102 to the main conductive plane 206.

The EEVI 112 is positioned at the first end 124 of the side edge 107, and the EEVI 116 is positioned at the second end 126 of the side edge 107. The EEVA 110, the EEVI 114, and the EEVA 108 are each positioned between the EEVI 112 and the EEVI 116 along the side edge 107. By being at the first end 124 and second end 126 of the side edge 107, the EEVIs 112, 116 provide isolation for the EEVAs 110, 108 so that the RF device 100 can be used as a module. The EEVIs 112, 116 are the initial conductive plane disruptions through which currents along the side edge 107 pass and which do not pass through the EEVA , 108. The EEVAs , 108 see these EEVIs 112, 116 as series inductors. For this reason, the edge currents will be less impacted by disruptions due to the module conductive plane 102 being connected to the main conductive plane 206. Again, the EEVI 112, 116 thus provide the isolation needed so that the RF device 100 can be utilized without special consideration of the impact of the main printed circuit board 202. The shape of the main printed circuit board 104 on which the RF device 100 is mounted may decrease the antenna impedance. The EEVIs 112, 116 make sure the impact of module placement tolerances are less visible in performance and thus allow for the RF device 100 to be mounted to the main printed circuit board 202 without taking into account the shape of the main printed circuit board 202.

In FIG. 2, the main printed circuit board 202, including the main substrate 204 the main conductive plane 206, defines a side edge 210 that is parallel with the side edge 107 of the RF device 100 when the RF device 100 is mounted to the main conductive plane 206, as shown with the RF device 200. A portion of the main printed circuit board 202 is cut out relative to the side edge 210. The side edge 107 of the printed circuit board 104, including the module substrate 106 and the module conductive plane 102, is retracted with respect to the side edge 210 of the main printed circuit board 202.

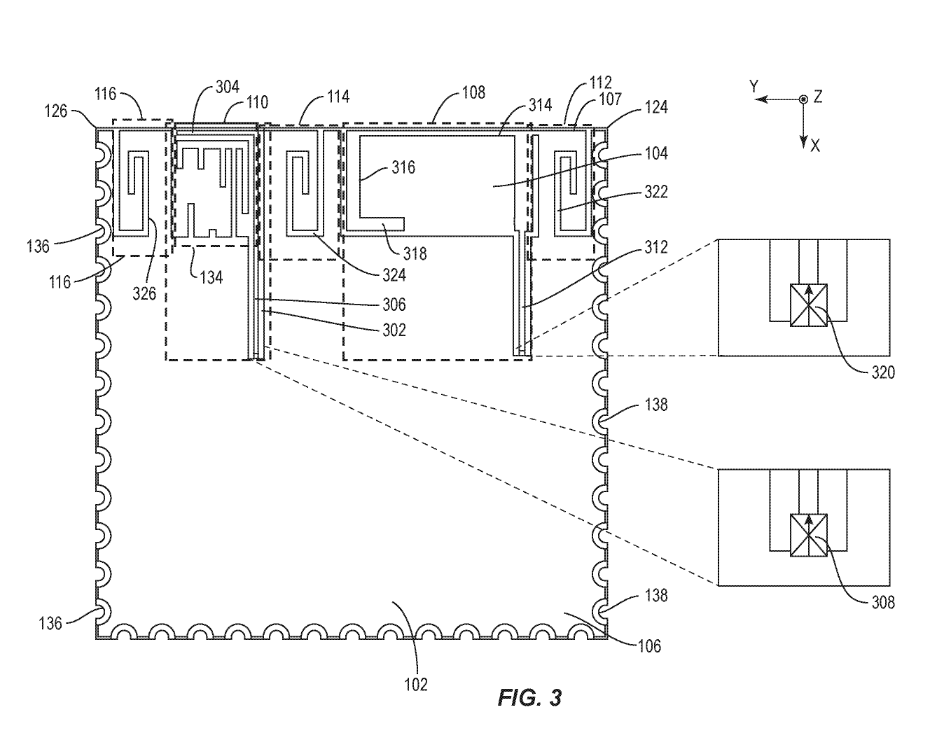

FIG. 3 is a top view of the printed circuit board 104 shown in FIG. 1, in accordance with some embodiments.

FIG. 3 is illustrated to more clearly show the EEVIs 112, 114, 116 and the EEVAs 108, 110, along with additional features not explicitly shown in FIG. 1. The printed circuit board 104, including the EEVIs 112, 114, 116 and the EEVAs 108, 110 in the module conductive plane 102, are arranged as described above with respect to FIG. 1. As is more clearly shown in FIG. 3, the module conductive plane 102 includes the passive matching elements 134 within the EEVC void of the EEVA 110. In this example, the EEVA 110 is formed by an L-shaped section 302 that partially surrounds the EEVC void of the EEVA 110. One leg 304 of the L-shaped section 302 is parallel to the Y-axis and is positioned along the side edge 107. Another leg 306 of the L-shaped section 302 is parallel to the X-axis and is connected to an end of the leg 304. The leg 306 extends into the module conductive plane 102. An RF port 308 is connected to an extreme end of the leg 306 that is away from the leg 304. RF signals may be transmitted and received electronic components (e.g., the electronic components 108 shown in FIG. 1) to and from the EEVA 110.

The passive matching elements 134 are formed by the module conductive plane 102 and appear as a matching network of passive capacitors and passive inductors to the EEVA 110. The passive matching elements 134 provide matching for the EEVA 110 and make the EEVA more broadband.

The module conductive plane 102 provides legs 312, 314, 316, 318 of the EEVA 108. The leg 314 is parallel to the Y-axis and is positioned along the side edge 107. The leg 312 is connected to one end of the leg 314 and extends into the module conductive plane 102 parallel to the X-axis. An RF port 320 is connected to an extreme end of the leg 312 that is away from the section 314. In this manner, the EEVA 108 is configured to transmit and receive RF signals from electronic components (e.g., the electronic components 108 shown in FIG. 1). The leg 316 extends from another end of the leg 314 into the module conductive plane 102. The leg 316 is parallel to the X-axis. The leg 318 is connected to an end of the leg 316 that is away from the leg 314. The leg 318 is parallel to the Y-axis but is not as long as the leg 314. Thus, the legs 312, 314, 316, 318 partially enclose the EEVC void of the EEVA 108.

The module conductive plane 102 is formed into a curl 322 that forms the EEVI 112, wherein the EEVC void of the EEVI 112 is formed as a meandering path defined by the curl 322. In this embodiment, the curl 322 is a rectangular curl. In other embodiments, the curl 322 may have any other shape such as a circular or elliptical curl. The EEVI 112 is not connected to an RF port. Thus, no conductor is formed that connects the EEVI 112 to an RF port.

The module conductive plane 102 is formed into a curl 324 that forms the EEVI 114, wherein the EEVC void of the EEVI 114 is formed as a meandering path defined by the curl 324. In this embodiment, the curl 324 is a rectangular curl. In other embodiments, the curl 324 may have any other shape such as a circular or elliptical curl. The EEVI 114 is not connected to an RF port. Thus, no conductor is formed that connects the EEVI 114 to an RF port.

The module conductive plane 102 is formed into a curl 326 that forms the EEVI 116, wherein the EEVC void of the EEVI 116 is formed as a meandering path defined by the curl 326. In this embodiment, the curl 326 is a rectangular curl. In other embodiments, the curl 326 may have any other shape such as a circular or elliptical curl. The EEVI 116 is not connected to an RF port. Thus, no conductor is formed that connects the EEVI 116 to an RF port.

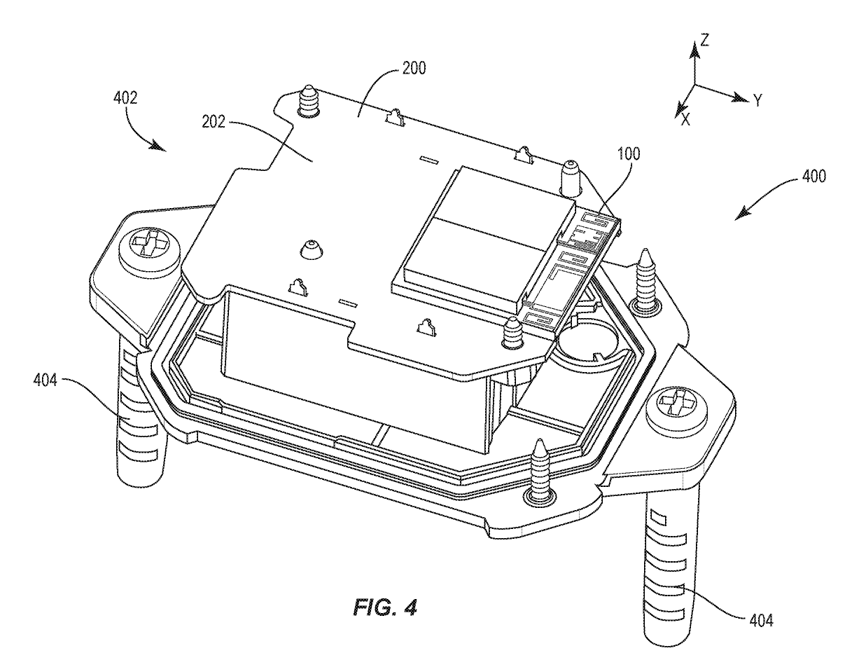

FIG. 4 is a mountable RF antenna module 400 in accordance with some embodiments.

The mountable RF antenna module 400 includes a frame 402 and the RF device 200 described above with respect to FIG. 2 mounted to the frame 402. More specifically, the main printed circuit board 202 is mounted to the frame 402. The RF device 100 is mounted to the RF device 200. In this embodiment, screws 404 are provided in order to mount the RF antenna module to the chassis of a user element (not explicitly shown in FIG. 4). However, any suitable mounting mechanism may be utilized to mount the mountable RF antenna module 400 to the chassis of a user element.

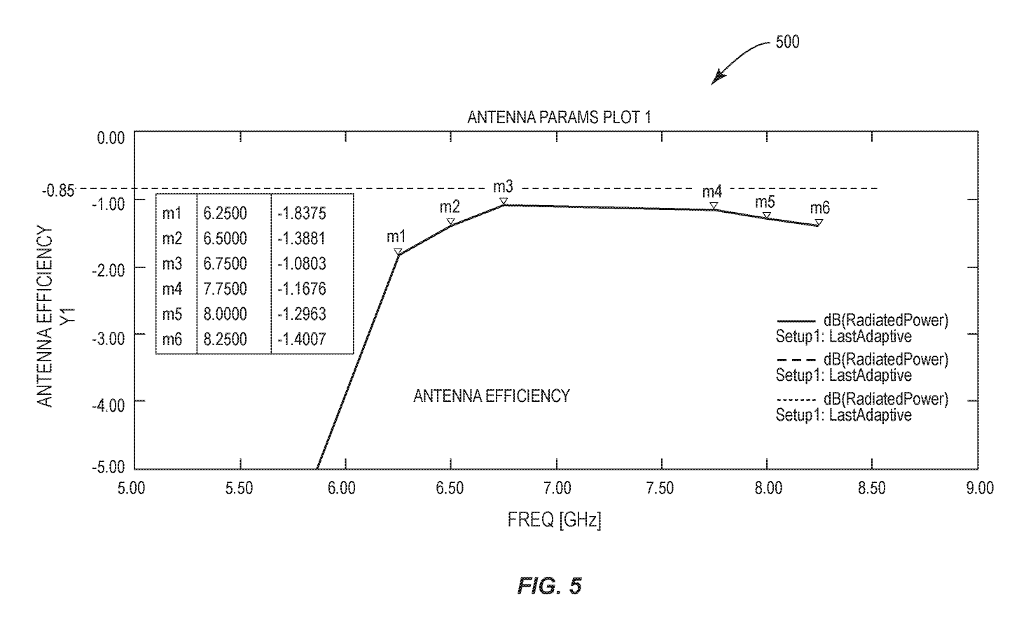

FIG. 5 is a graph 500 that illustrates the antenna efficiency of the EEVA 110 shown in FIG. 1, FIG. 2, and FIG. 3 versus frequency, in accordance with some embodiments.

As discussed above, the EEVA 110 is a UWB antenna. The graph 500 illustrates that the EEVA 110 has an antenna efficiency above −2dB at frequencies greater than 6GHz and an antenna efficiency of close to −1dB at frequencies greater than 6.5 GHz to 8.25GHz. As a result of the EEVI 112, 116 and the passive matching elements 134, the EEVA 110 not only can cover frequencies in CH9 but also in CH5 by maintaining antenna efficiency throughout these frequency bands.

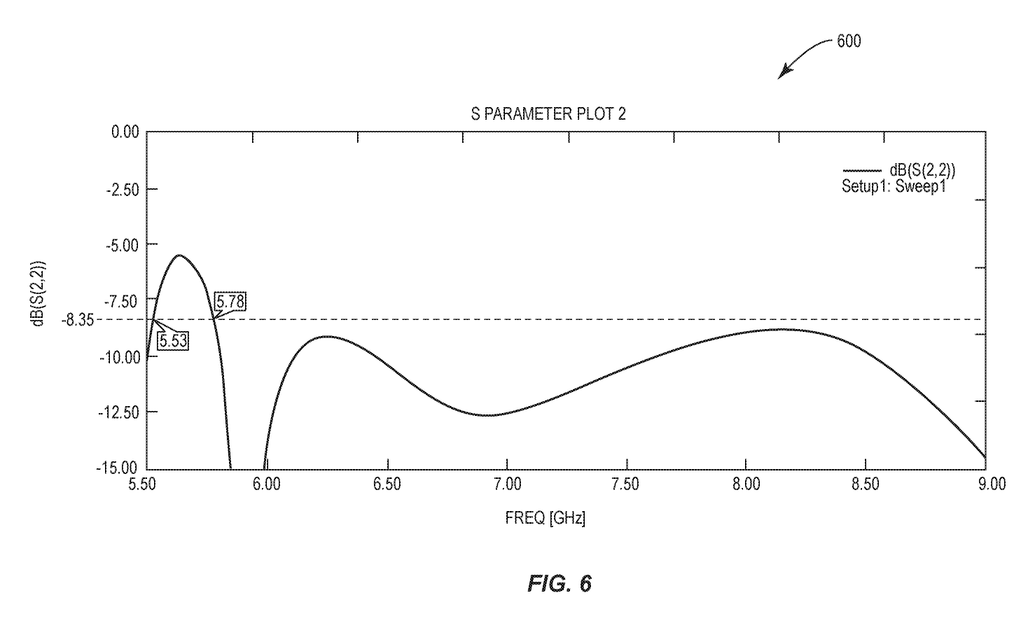

FIG. 6 is a graph 600 that illustrates an S22 parameter in decibels of the EEVA 110 shown in FIG. 1, FIG. 2, and FIG. 3 versus frequency, in accordance with some embodiments.

The graph 600 illustrates that the S22 parameter of the antenna remains above −12.5 dB at frequencies just above 6GHz and up to 8.6GHz. It should be noted that the lower the S22 parameter is, the better the performance. The graph 600 illustrates that reflection resulting at .the RF port 308 (shown in FIG. 3) is low throughout CH5 and CH9 frequency bands. As a result of the EEVI 112, 116 and the passive matching elements 134, the EEVA 110 not only can cover frequencies in CH9 but also in CH5 by maintaining antenna efficiency throughout these frequency bands.

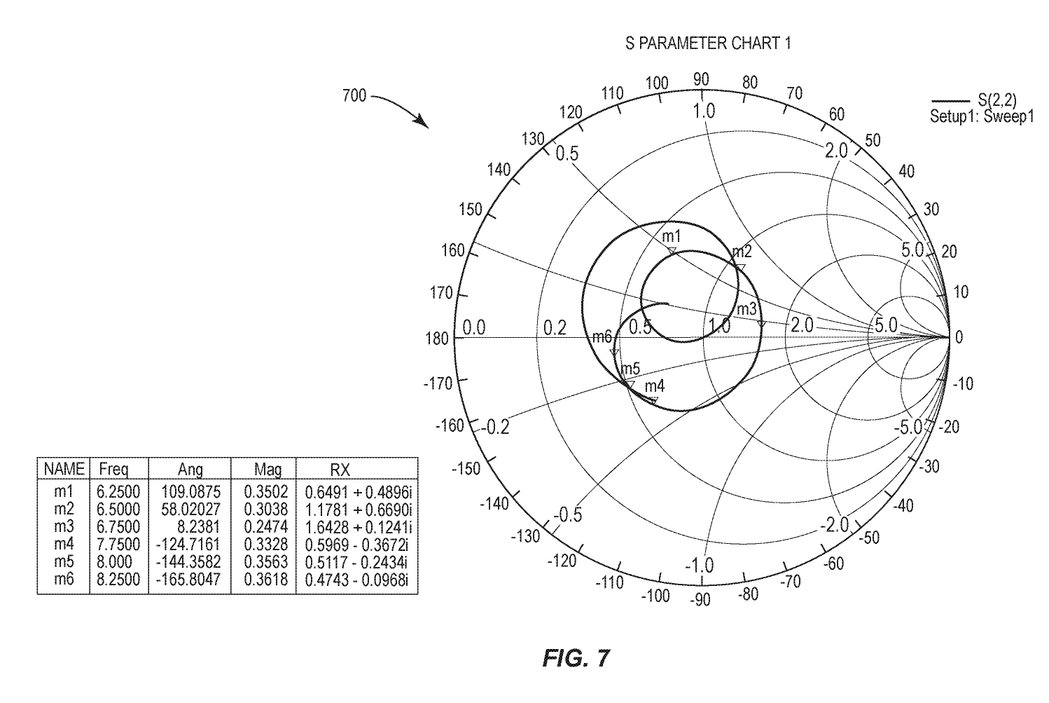

FIG. 7 is a Smith chart 700 that illustrates the antenna impedance as the S22 parameter of the EEVA 110 shown in FIG. 1, FIG. 2, and FIG. 3 throughout a frequency sweep, in accordance with some embodiments.

As shown by the Smith chart 700, the antenna impedance of the EEVA 110 remains relatively close to the center of the Smith chart throughout the frequency range of 6.25-8.25GHz. This illustrates relatively good antenna operation through the CH5 and CH9 frequency bands.

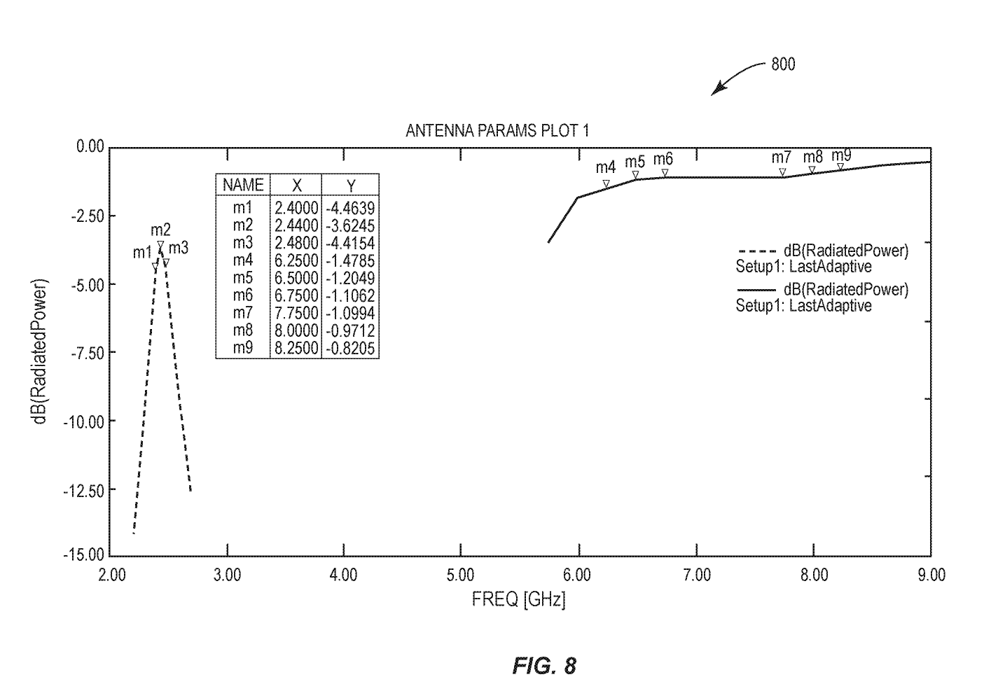

FIG. 8 is a graph 800 that illustrates radiated power from the EEVA 110 in decibels shown in FIG. 1, FIG. 2, and FIG. 3 versus frequency, in accordance with some embodiments.

As shown by FIG. 8, the radiated power remains close to 0dB throughout CH5 and CH9 frequency bands. This illustrates high power output of the EEVA 110 throughout operation the CH5 and CH9 frequency bands.

We note that the EEVA 108 in FIG. 1, FIG. 2, and FIG. 3, also has demonstrated consistent antenna efficiency due to the EEVIs 112, 116 throughout Bluetooth® bands regardless of the surrounding materials (wood, concrete, metal) presented to the EEVA 108.

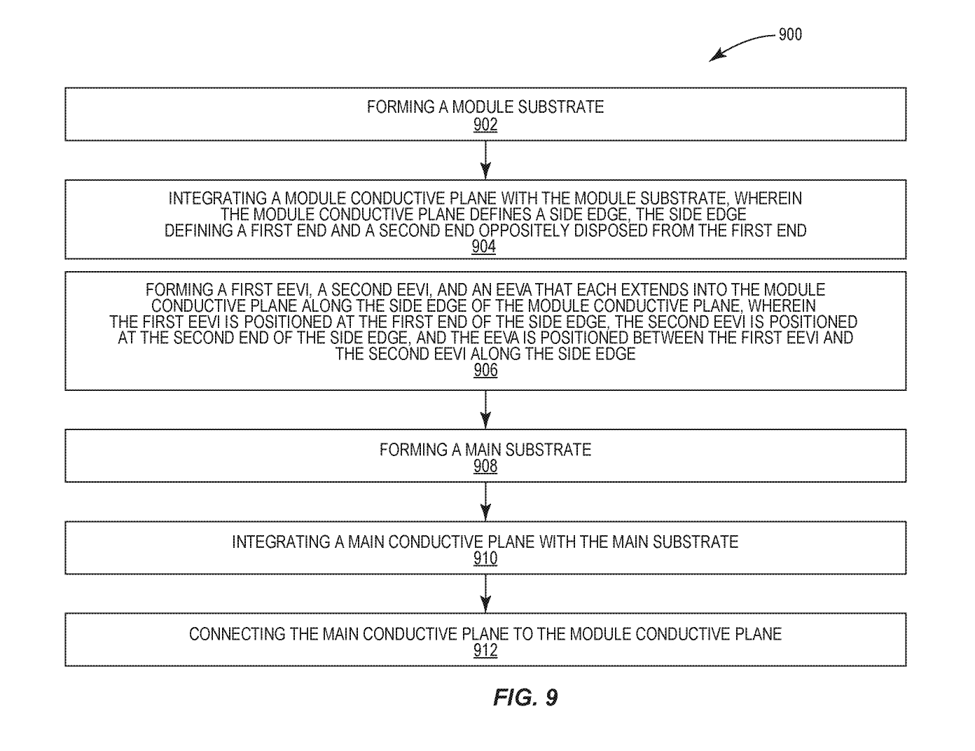

FIG. 9 is a flowchart 900 that illustrates a method of manufacturing an RF device, in accordance with some embodiments.

In some embodiments, the RF device manufactured is the RF device 200 shown in FIG. 2. This includes the RF device 100 shown in FIG. 1 and in FIG. 3 along with the main printed circuit board 202 shown in FIG. 2. Flowchart 900 includes blocks 902-912. Manufacturing and processing details of flowchart 900 will be understood by those skilled in the art. Flow begins at block 902.

At block 902, a module substrate is formed. An example of the module substrate is the module substrate 106 shown in FIG. 1, FIG. 2, and FIG. 3. Flow then proceeds to block 904.

At block 904, a module conductive plane is integrated with the module substrate, wherein the module conductive plane defines a side edge, the side edge defining a first end and a second end oppositely disposed from the first end. An example of the module conductive plane is the module conductive plane 102 shown in FIG. 1, FIG. 2, and FIG. 3. An example of the side edge is the side edge 107 shown in FIG. 1, FIG. 2, and FIG. 3. An example of the first end is the first end 124 shown in FIG. 1, FIG. 2, and FIG. 3 and an example of the second end is the second end 126 shown in FIG. 1, FIG. 2, and FIG. 3. Flow then proceeds to block 906.

At block 906, a first EEVI, a second EEVI, and an EEVA that each extend into the module conductive plane are formed along the side edge of the module conductive plane, wherein the first EEVI is positioned at the first end of the side edge, the second EEVI is positioned at the second end of the side edge, and the EEVA is positioned between the first EEVI and the second EEVI along the side edge. An example of the first EEVI is the EEVI 112 shown in FIG. 1, FIG. 2, and FIG. 3. An example of the second EEVI is the EEVI 116 shown in FIG. 1, FIG. 2, and FIG. 3. Examples of the EEVA are EEVA 108 and the EEVA 110.

At block 908, a main substrate is formed. An example of the main substrate is the main substrate 204 shown in FIG. 2. Flow then proceeds to block 910.

At block 910, a main conductive plane is integrated with the main substrate. An example of the main conductive plane is the main conductive plane 206 shown in FIG. 9. Flow then proceeds to block 912.

At block 912, the main conductive plane is connected to the module conductive plane. An example of this is shown by the side solder pads 136, 138 being connected by wires 209 to the main conductive plane 206 in FIG. 2.

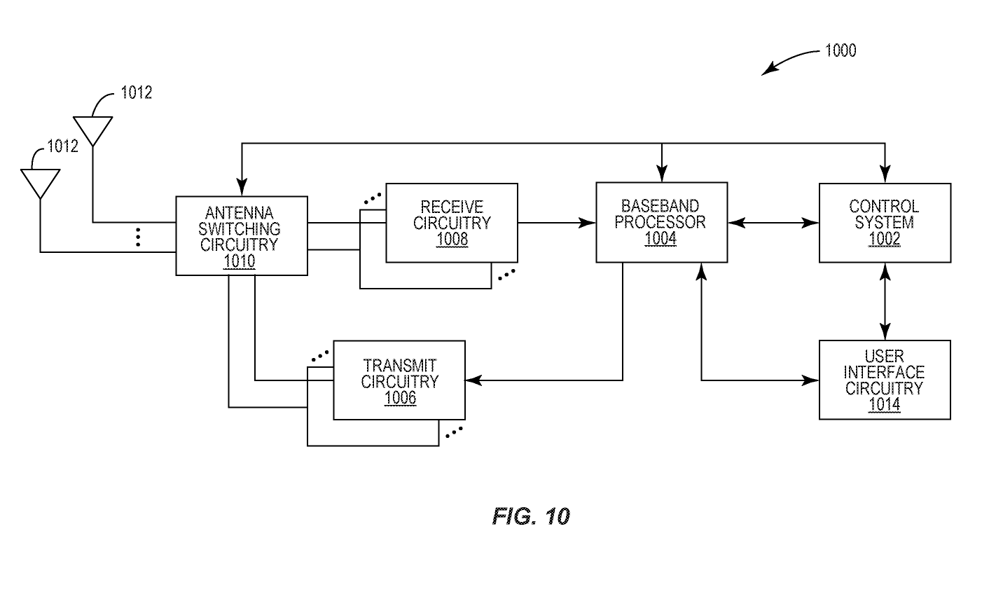

FIG. 10 is a user element, in accordance with some embodiments.

With reference to FIG. 10, the concepts described above may be implemented in various types of user elements 1000, such as mobile terminals, smart watches, tablets, computers, navigation devices, access points, and like wireless communication devices that support wireless communications, such as cellular, wireless local area network (WLAN), Bluetooth®, and near-field communications. The user element 1000 will generally include a control system 1002, a baseband processor 1004, transmit circuitry 1006, receive circuitry 1008, antenna switching circuitry 1010, multiple antennas 1012, and user interface circuitry 1014. In a non-limiting example, the control system 1002 may be a field-programmable gate array (FPGA) or an application-specific integrated circuit (ASIC). In this regard, the control system 1002 may include at least a microprocessor, an embedded memory circuit, and a communication bus interface. The receive circuitry 1008 receives radio frequency signals via the antennas 1012 and through the antenna switching circuitry 1010 from one or more base stations. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converters (ADCs).

The baseband processor 1004 processes the digitized received signal to extract the information or data bits conveyed in the received signal. This processing typically comprises demodulation, decoding, and error correction operations, as will be discussed in greater detail below. The baseband processor 1004 is generally implemented in one or more digital signal processors (DSPs) and application-specific integrated circuits (ASICs).

For transmission, the baseband processor 1004 receives digitized data, which may represent voice, data, or control information, from the control system 1002, which it encodes for transmission. The encoded data is output to the transmit circuitry 1006, where a digital-to-analog converter (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 1012 through the antenna switching circuitry 1010. The multiple antennas 1012 and the replicated transmit circuitry 1006 and receive circuitry 1008 may provide spatial diversity.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A radio frequency (RF) device, comprising:
a module substrate;
a module conductive plane integrated with the module substrate, wherein:
the module conductive plane defines a side edge;
the side edge defining a first end and a second end oppositely disposed from the first end;
the module conductive plane defining a first edge-enabled void isolator (EEVI), a second EEVI, and an edge-enabled void antenna (EEVA) that each extends into the module conductive plane along the side edge of the module conductive plane;
the first EEVI being positioned at the first end of the side edge;
the second EEVI being positioned at the second end of the side edge; and
the EEVA being positioned between the first EEVI and the second EEVI along the side edge.

2. The RF device of claim 1, further comprising:
a main substrate;
a main conductive plane integrated with the main substrate, wherein the main conductive plane is connected to the module conductive plane.

3. The RF device of claim 2, wherein:
the side edge is a first side edge;
the module conductive plane defines a second side edge and a third side edge;
the second side edge extends from the first end of the first side edge;
the third side edge extends from the second end of the first side edge;
the first EEVI is positioned at the second side edge; and
the second EEVI is positioned at the third side edge.

4. The RF device of claim 3, further comprising:
first side solder pads along the second side edge, the first side solder pads connecting the first EEVI to the main conductive ground plane;
second side solder pads along the third side edge, the second side solder pads connecting the second EEVI to the main conductive ground plane.

5. The RF device of claim 2, wherein:
the main substrate and the main conductive plane define a printed circuit board (PCB) side edge;
the side edge of the module conductive plane is retracted with respect to the PCB side edge.

6. The RF device of claim 2, wherein the module substrate is mounted on the main substrate.

7. The RF device of claim 1, wherein the EEVA is a first EEVA and wherein:
the module conductive plane defines a second EEVA and a third EEVI that each extends into the module conductive plane along the side edge of the module conductive plane;
the second EEVA and the third EEVI being positioned between the first EEVI and the second EEVI along the side edge; and
the third EEVI being positioned between the first EEVA and the second EEVA along the side edge.

8. The RF device of claim 7, wherein the first EEVA is a Bluetooth® Low Energy (BLE) antenna and the second EEVA is an ultra wideband (UWB) antenna.

9. The RF device of claim 1, wherein the conductive plane defines one or more passive matching elements that are formed in a void of the EEVA, the passive matching elements being configured to provide matching for the EEVA.

10. The RF device of claim 1, further comprising a mounting area for mounting at least one electronic component, the first EEVI, the second EEVI, and the EEVA being outside of the mounting area.

11. A method of manufacturing a radio frequency (RF) device, comprising:
forming a module substrate;
integrating a module conductive plane with the module substrate, wherein the module conductive plane defines a side edge, the side edge defining a first end and a second end oppositely disposed from the first end;
forming a first edge enabled void isolator (EEVI), a second EEVI, and an edge enabled void antenna (EEVA) that each extends into the module conductive plane along the side edge of the module conductive plane, wherein the first EEVI is positioned at the first end of the side edge, the second EEVI is positioned at the second end of the side edge, and the EEVA is positioned between the first EEVI and the second EEVI along the side edge.

12. The method of claim 11 further comprising:
forming a main substrate;
integrating a main conductive plane with the main substrate; and
connecting the main conductive plane to the module conductive plane.

13. A user element that includes a radio frequency (RF) device, the RF device comprising:
a module substrate;
a module conductive plane integrated with the module substrate, wherein:
the module conductive plane defines a side edge;
the side edge defining a first end and a second end oppositely disposed from the first end;
the module conductive plane defining a first edge-enabled void isolator (EEVI), a second EEVI, and an edge-enabled void antenna (EEVA) that each extends into the module conductive plane along the side edge of the module conductive plane;
the first EEVI being positioned at the first end of the side edge;
the second EEVI being positioned at the second end of the side edge; and
the EEVA being positioned between the first EEVI and the second EEVI along the side edge.

14. The user element of claim 13, wherein the RF device further comprises:
a main substrate;
a main conductive plane integrated with the main substrate, wherein the main conductive plane is connected to the module conductive plane.

15. The RF device of claim 14, wherein:
the side edge is a first side edge;
the module conductive plane defines a second side edge and a third side edge;
the second side edge extends from the first end of the first side edge;
the third side edge extends from the second end of the first side edge;
the first EEVI is positioned at the second side edge; and
the second EEVI is positioned at the third side edge.

16. The RF device of claim 15, further comprising:
first side solder pads along the second side edge, the first side solder pads connecting the first EEVI to the main conductive ground plane;
second side solder pads along the third side edge, the second side solder pads connecting the second EEVI to the main conductive ground plane.

17. The RF device of claim 14, wherein:
the main substrate and the main conductive plane define a printed circuit board (PCB) side edge; and
the side edge of the module conductive plane is retracted with respect to the PCB side edge.

18. The RF device of claim 14, wherein the module substrate is mounted on the main substrate.

19. The RF device of claim 13, wherein the EEVA is a first EEVA and wherein:
the module conductive plane defines a second EEVA and a third EEVI that each extends into the module conductive plane along the side edge of the module conductive plane;
the second EEVA and the third EEVI being positioned between the first EEVI and the second EEVI along the side edge; and
the third EEVI being positioned between the first EEVA and the second EEVA along the side edge.

20. The RF device of claim 19, wherein the first EEVA is a Bluetooth® Low Energy (BLE) antenna and the second EEVA is an ultra wideband (UWB) antenna.
